(19) United States
(12) Patent Application Publication
(10) Pub. No.: US 2006/0110164 A1
(43) Pub. Date: May 25, 2006

(54) Multiple PCBA transceiver

(76) Inventors: Kirk Cook, Lyons, CO (US); Yung-Shun Wu, Longmont, CO (US); James Duncan, Loveland, CO (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/993,251

(22) Filed: Nov. 19, 2004

(51) Int. Cl. H04B 10/00

(52) U.S. Cl. 398/135

(57) ABSTRACT

A transceiver including a transmitter, a receiver, a first printed circuit board assembly, and a second printed circuit board assembly. The transmitter is configured to convert electrical signals to fiber optic signals. The receiver is configured to convert fiber optic signals to electrical signals. The first printed circuit board assembly is electrically coupled with the transmitter and configured to be electrically coupled with a host system via a first plurality of host interface pins. The second printed circuit board assembly is electrically coupled with the receiver and configured to be electrically coupled with the host system via a second plurality of host interface pins.

### BACKGROUND

Fiber optic transceivers are used in a variety of applications, including storage area networks (SANs), local area networks (LANs), Fibre Channel, Gigabyte Ethernet, and synchronous optical network (SONET) applications. Fiber optic transceivers can be used as the network interface in mainframe computers, workstations, servers, storage devices, etc. Fiber optic transceivers can also be used in a broad range of network device, such as bridges, routers, hubs, and local and wide area switches.

Fiber optic transceivers generally include a transmitter and a receiver. Typically, the transmitter and receiver are each part of separate optical subassemblies within the fiber optic transceiver. Each optical subassembly is optically connected to a different fiber optic cable and electrically connected to a printed circuit board assembly (PCBA). Fiber optic systems use light pulses to transmit information through the fiber optic cables to the receiver. The optical subassembly including the receiver generally translates or converts the fiber optic data into electrical data signals to be forwarded to the computer, workstation, server, storage device, etc. The optical subassembly including the transmitter is configured to receive electrical data signals, translate the electrical data signals into fiber optic data, and to forward to the fiber optic system via the transmitter and the corresponding fiber optic cable.

One type of optical subassembly is a bi-directional subassembly. A bi-directional optical subassembly includes both the receiver and the transmitter and has the ability of transmitting and receiving full duplex communications on a single fiber optic cable. Use of a single fiber optic cable saves overall system costs by eliminating one cable from the traditional dual fiber optic cable model. In this respect, the bi-directional optical subassembly allows for doubling the capacity of the transceiver without installing new fibers and simplifies overall fiber management. Typically, the bi-directional optical subassembly interfaces with a single PCBA, which in turn is configured to be electrically coupled to the computer workstation, server, storage device, etc. Accordingly, the PCBA electrically couples with both the transmitter and the receiver. In order to align with the transmitter and the receiver in view of manufacturing tolerances, the PCBA conventionally incorporates at least a flexible portion of the PCBA.

### SUMMARY

One embodiment of the invention provides a transceiver including a transmitter, a receiver, a first printed circuit board assembly, and a second printed circuit board assembly. The transmitter is configured to convert electrical signals to fiber optic signals. The receiver is configured to convert fiber optic signals to electrical signals. The first printed circuit board assembly is electrically coupled with the transmitter and configured to be electrically coupled with a host system via a first plurality of host interface pins. The second printed circuit board assembly is electrically coupled with the receiver and configured to be electrically coupled with the host system via a second plurality of host interface pins.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective view of one embodiment of a transceiver.

FIG. 2 is a perspective view of one embodiment of a bottom housing of the transceiver of FIG. 1.

FIG. 3 is a perspective view of one embodiment of an optical subassembly of the transceiver of FIG. 1.

FIG. 4 is a perspective view of one embodiment of a first printed circuit board assembly (PCBA) of the transceiver of FIG. 1.

FIG. 4A is a cross-sectional view of the first PCBA of FIG. 4 taken along the line A-A.

FIG. 5A is a perspective view of one embodiment of a first side of a second PCBA of the transceiver of FIG. 1.

FIG. 5B is a perspective view of one embodiment of a second side of a second PCBA of the transceiver FIG. 1.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

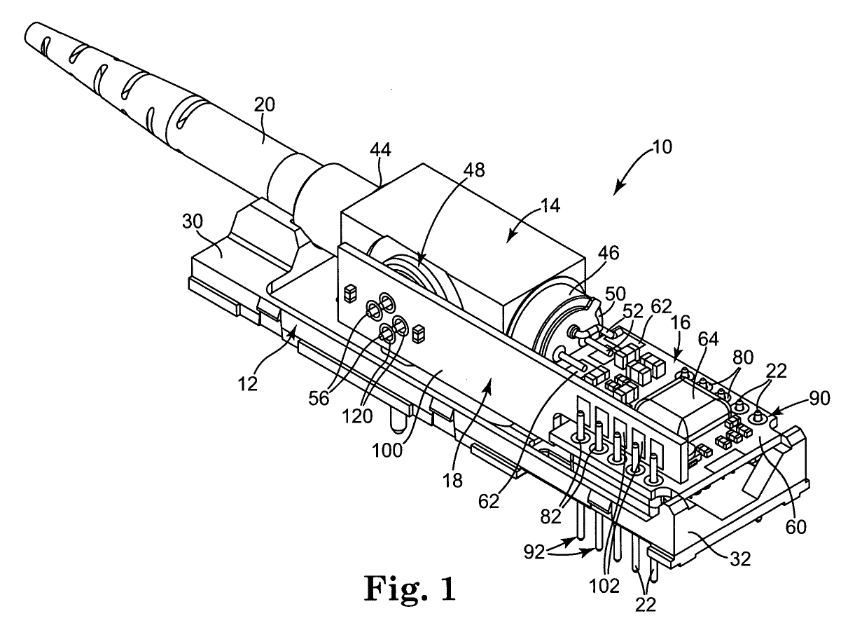

FIG. 1 illustrates one embodiment of a transceiver at 10. Transceiver 10 includes a bottom housing 12, an optical subassembly (OSA) 14, a first printed circuit board assembly (PCBA) 16, and a second PCBA 18. OSA 14, first PCBA 16, and second PCBA 18 are assembled and placed upon bottom housing 12. A fiber optic cable 20 is permanently or selectively plugged into OSA 14 and provides an optical communication link to and from transceiver 10. OSA 14 is independently and electrically connected to each of first PCBA 16 and second PCBA 18, which are each configured to be electrically coupled to a host system (not shown), such as a mainframe computer, a computerized workstation, a server, a storage device, etc.

Accordingly, OSA 14 receives electrical signals from first PCBA 16 and converts the signal to fiber optic signals for transmission to external sources through fiber optic cable 20. Conversely, OSA 14 receives fiber optic signals from fiber optic cable 20 through second PCBA 18 and translates the signals into electrical signals. With this in mind, fiber optic signals are received and transmitted through the single fiber optic cable 20. In one embodiment, electrical signals are communicated between a host system and OSA 14 via PCBAs 16 or 18 wherein each PCBA independently communicates with OSA 14 and host system via a plurality of host interface pins 22 extending from transceiver 10.

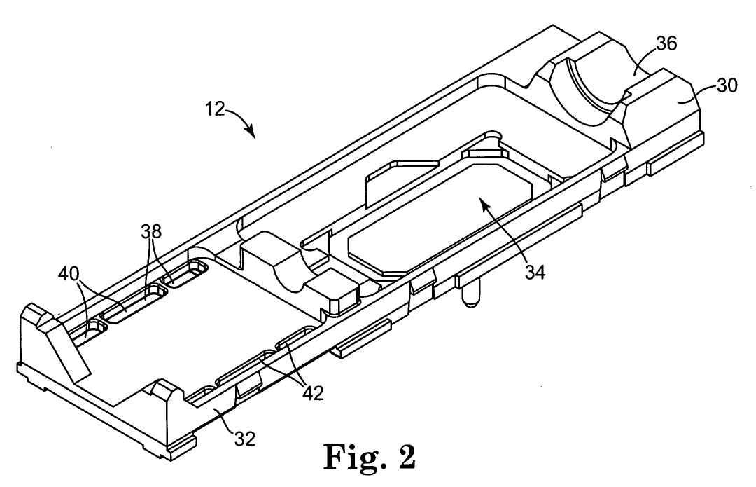

FIG. 2 illustrates one embodiment of bottom housing 12 defining a first or front end 30 and a second or back end 32. An OSA reception cavity 34 is defined near first end 30 and is configured to receive OSA 14. In one embodiment, a cradle 36 is additionally defined near first end 30 for selectively or permanently receiving and partially supporting fiber optic cable 20 near the fiber optic cable 20 interface with OSA 14. In one embodiment, at least one pin reception aperture 38 extends through bottom housing 12 near second end 32. Each pin reception aperture 38 is configured to receive one or more of the plurality of host interface pins 22 (FIG. 1) electrically connected to one or more of the PCBAs 16 and 18.

In one embodiment, the at least one pin reception aperture 38 is a plurality of apertures 38 including a first portion of apertures 40 and a second portion of apertures 42 laterally spaced from first portion of apertures 40. Each of the first portion of apertures 40 are linearly spaced from each other along a longitudinal side of bottom housing 12. Similarly, each of second portion of apertures 42 are linearly spaced from each other along an opposing longitudinal side of bottom housing 12.

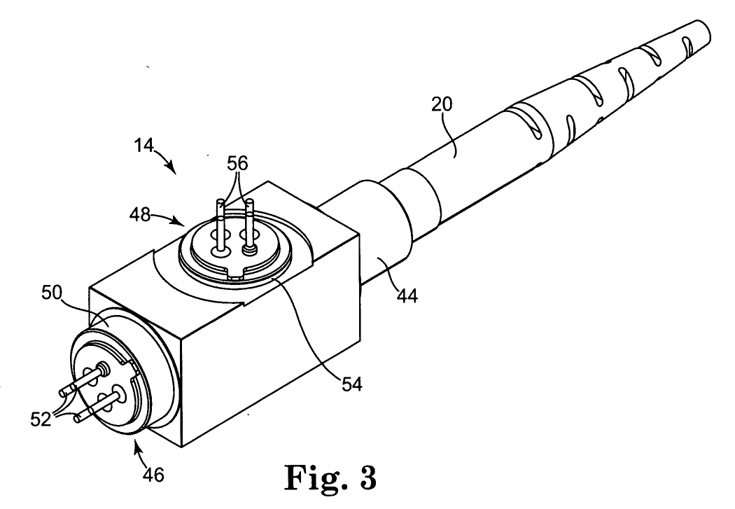

FIG. 3 illustrates one embodiment of OSA 14. OSA 14 is any optical subassembly capable of converting fiber optic signals to electrical signals and/or electrical signals to fiber optic signals. In one embodiment, OSA 14 is a bi-directional OSA and includes a cable receptor 44, a transmitter 46, and a receiver 48. Cable receptor 44 selectively or permanently receives and is fiber optically connected to fiber optic cable 20.

Transmitter 46 generally includes a driver circuit and an optical emitter that are electrically coupled to each other. In one embodiment, the optical emitter is a laser or LED. The driver circuit receives a modulated electrical signal that contains information that is to be transmitted over fiber optic cable 20 in the form of a modulated fiber optic signal. The driver circuit is coupled to the laser or LED and is configured to cause the light-emitting device to generate a modulated optical signal based upon the modulated electrical signal received.

In one embodiment, transmitter 46 includes a circular protrusion 50 extending out an end of OSA 14 opposite cable receptor 44. A plurality of pins 52 extend out from circular protrusion 50. In one embodiment, the plurality of pins 52 includes four pins 52 arranged in a rectangular array collectively and generally centered upon an outer face of circular protrusion 50. In one embodiment, each of the pins 52 is formed of an electrically conducive material. In this respect, transmitter 46 is configured to convert electrical signals received via pins 52 to fiber optic signals for transmission via fiber optic cable 20.

Receiver 48 generally includes an optical detector and related electrical circuitry. The optical detector receives a fiber optic signal from the fiber optic cable 20 and converts the fiber optic signal into a modulated electrical signal proportional to the optical signal. In one embodiment, receiver 48 defines a circular protrusion 54 extending out from a side of OSA 14 between cable receptor 44 and transmitter 46.

In one embodiment, a plurality of pins 56 extend outward from circular protrusion 54. In one example, the plurality of pins 56 includes four pins 56 arranged in a rectangular array, which are collectively and generally centered on protrusion 54. Each of pins 56 are formed of an electrically conducive material. With this in mind, receiver 48 is configured to convert fiber optic signals to electrical signals for transmission to PCBA 18 and pins 52. Since the OSA 14 described herein includes both a transmitter 46 and a receiver 48, OSA 14 is able to convert electrical signals to fiber optic signals and vice versa. In this respect, transceiver 10 is a bi-directional transceiver.

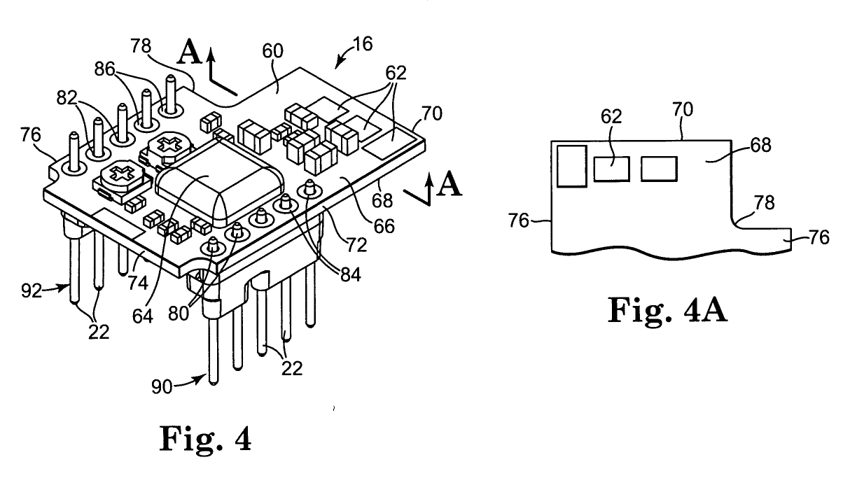

FIGS. 4 and 4A illustrate a perspective view and a cross-sectional view, respectively, of first PCBA 16 including a printed circuit board (PCB) 60, a plurality of connection pads 62, an integrated circuit 64, and host interface pins 22. In one embodiment, PCB 60 defines a first surface 66 and a second surface 68 opposite first surface 66. PCB 60 includes a first edge 70, a second edge 72, a third edge 74, and a fourth edge 76 each extending between first surface 66 and second surface 68. Second edge 72 generally extends from first edge 70 towards third edge 74. Third edge 74 generally extends from second edge 72 to fourth edge 76. Fourth edge 76 generally extends from third edge 74 towards first edge 70. An elongated notch 78 is defined from first edge 70 extending particularly towards third edge 74 and through fourth edge 76. In this respect, PCB 60 is generally L-shaped. In one example, PCB 60 is formed of a UL recognized material and traceable for a VO minimum flammability rating.

In one embodiment, the plurality of connection pads 62 includes three connection pads 62 placed upon first surface 66 of PCB near first edge 70. With additional reference to FIG. 4A, in one embodiment, at least one additional connection pad 62 is also secured to second surface 68 of PCB 60. In one embodiment, each connection pad 62 is formed of one or more of gold, nickel, copper, or any other suitable electrically conductive material. In a particular example, each connection pad 62 is a layer of gold over a layer of nickel over a layer of copper in PCB 60.

In one embodiment, PCB 60 additionally defines a plurality of apertures 80 linearly spaced from each other and collectively and extending along a portion of second edge 72. Each of the plurality of apertures 80 includes a circular ring or plating 84 extending about and through the respective aperture 80. A plurality of similar apertures 82 are linearly spaced and collectively extend along a portion of fourth edge 76. In one embodiment, apertures 80 are symmetrically positioned with respect to apertures 82. Each of the plurality of apertures 82 includes a circular ring or plating 86 extending about and through the respective aperture 82. In one embodiment, each plating 84 and 86 is formed of one or more of gold, nickel, copper, or any other suitable electrically conductive material. In a particular example, each plating 84 and 86 is a layer of gold over a layer of nickel over a layer of copper in PCB 60.

Integrated circuit 64 is configured to electrically control the transmitter 46 and is positioned upon PCB 60 between the plurality of apertures 80 and the plurality of apertures 82. In one embodiment, integrated circuit 64 is generally positioned near and electrically coupled to the plurality of connection pads 62 to decrease noise interference in the electrical communication between connection pads 62 and integrated circuit 64. In addition, integrated circuit 64 is electrically connected to the plurality of apertures 80. In one embodiment, integrated circuit is additionally electrically connected to a plurality of apertures 82.

Host interface pins 22 are electrically and mechanically secured to PCB 60 through the plurality of apertures 80 and 82. More specifically, the plurality of host interface pins 22 includes a first linear array of pins 90 and a second linear array of pins 92. Each of the first linear array of pins 90 are positioned through apertures 80 and soldered to plating 84. Each of the second linear array of pins 92 are positioned through apertures 82 and soldered to the corresponding plating 86. Accordingly, each pin 22 is electrically and/or mechanically connected to PCB 60.

In one embodiment, each of the second array of pins 92 extends from first surface 66 of PCB 60 a greater distance than each of the first array of interface pins 90 extends from first surface 66. In one embodiment, all of host interface pins 22 extend through the respective apertures 80 or 82 a similar distance from second surface 68 of PCB 60. In this respect, the portion of host interface pins 22 extending from second surface 68 are configured to interface with the host system. In one embodiment, apertures 80 and 82, and therefore pins 22, are arranged to interface with a host system in accordance with the Small Form Factor or Small Form Factor Pluggable Multisource Agreement.

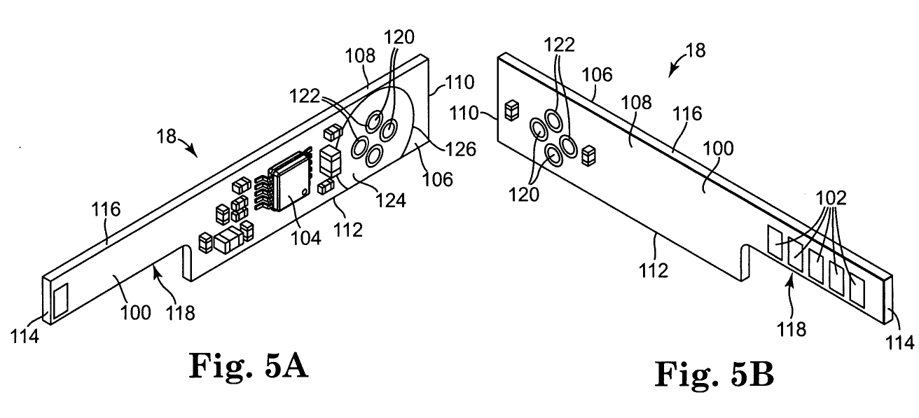

FIGS. 5A and 5B illustrate the two perspective side views of one embodiment of second PCBA 18. Second PCBA 18 generally includes a printed circuit board (PCB) 100, a plurality of connection pads 102, and an integrated circuit 104. PCB 100 defines a first surface 106 and a second surface 108 opposite first surface 106. PCB 100 additionally defines a first edge 110, a second edge 112, a third edge 114, and a fourth edge 116 each extending between first and second surfaces 106 and 108. More specifically, second edge 112 generally extends from first edge 110 towards third edge 114. Third edge 114 generally extends between second edge 112 and fourth edge 116. Fourth edge 116 generally extends between third edge 114 and first edge 110. In one embodiment, an elongated notch 118 generally extends from third edge 114 towards first edge 110 and through second edge 112.

In one embodiment, a plurality of apertures 120 are defined relatively near first edge 110. In one example, the plurality of apertures 120 includes four apertures 120 positioned in a generally square array spaced on center a distance similar to the spacing of the plurality of pins 56 of receiver 48 extending from OSA 14. Each of the plurality of apertures 120 includes a ring or plating 122 extending about and through each aperture 120. In one embodiment, plating 122 is copper, nickel, gold, or any other suitable electrically conductive material. In a particular example, plating 122 is a layer of gold over a layer of nickel over a layer of copper on PCB 100.

In one embodiment, a keep out area 124 is indicated upon PCB 100 by a printed ring 126 extending around the plurality of apertures 120. Keep out area 124 defined within ring 126 indicates an area of PCB 100 in which additional PCB components should not be connected. In one embodiment, keep out area 124 corresponds to the surface area of the outer surface of circular protrusion 54 of receiver 48. In a particular example, keep out area 124 and ring 126 have a diameter of about 7 mm.

Integrated circuit 104 is configured to electrically control receiver 48. In one embodiment, integrated circuit 104 is a post-amplifier. In one embodiment, integrated circuit 104 is generally positioned near to keep out area 124. Positioning integrated circuit 104 relatively near to keep out area 124 will, upon assembly, inherently position integrated circuit 104 relatively near receiver 48, as will be further described below. Positioning integrated circuit 104 near receiver 48 increases the integrity of the electrical connection between integrated circuit 104 and receiver 48 and decreases noise or other interferences to the electrical communication between integrated circuit 104 and receiver 48. In one embodiment, integrated circuit 104 is positioned less than about 10 mm from each of the plurality of apertures 120.

Connection pads 102 are secured to second surface 108 of PCB 100 relatively near third and fourth edges 114 and 116. In particular, each connection pad 102 is spaced a sequentially larger distance from third edge 114 along fourth edge 116. In one embodiment, each pad 102 is positioned adjacent to elongated notch 118. Each connection pad 102 is configured to interact with one of the second array of pins 92 (illustrated in FIG. 4). In one embodiment, each connection pad 102 is formed of one or more of nickel, copper, gold, or any other suitable electrically conductive material. In a particular embodiment, each connection pad 102 is formed by a layer of gold placed over a layer of nickel placed over a layer of copper interfacing with PCB 60. Each connection pad 102 is sufficiently wide (extends in a distance parallel to second edge 112 and fourth edge 116 a distance) to allow for alignment with the respective host interface pins 22. In a specific example, each connection pad 102 extends in this distance in the range of about 1 mm to about 1.5 mm. In addition, in one embodiment, each connection pad 102 extends in a distance parallel to first edge 110 and third edge 114 a distance of about 2.6 mm to about 3.2 mm. Each connection pad 102 is electrically connected to integrated circuit 104.

In order to assemble transceiver 10, OSA 14 is placed upon bottom housing 12. More particularly, OSA 14 is placed at least partially within OSA reception cavity 34 such that fiber optic cable 20 extends through cradle 36 of bottom housing 12. In this respect, upon placement within OSA reception cavity 34, OSA 14 is positioned such that transmitter 46 extends towards second end 32 of bottom housing 12 and receiver 48 extends from OSA 14 in a direction generally perpendicular to the general extension of bottom housing 12 between first end 30 and second end 32. In one embodiment, fiber optic cable 20 is permanently secured to OSA 14. In another embodiment, fiber optic cable 20 is selectively secured to OSA 14. In this respect, upon attachment with OSA 14, fiber optic cable 20 extends from OSA 14 beyond first end 30 of bottom housing 12. Accordingly, fiber optic cable 20 fits within cradle 36 of bottom housing 12 for attachment to a fiber optic system.

First PCBA 16 is also placed on or within bottom housing 12. More specifically, first PCBA 16 is placed upon bottom housing 12 such that host interface pins 22 extend through pin reception apertures 38 of bottom housing 12. In particular, each host interface pin 22 extends beyond second surface 68 of PCB 60 and through pin reception apertures 38 in a manner configured to interface with the host system. More specifically, first array of pins 90 extend through first portion of apertures 44, and second array of pins 92 extend through second portion of apertures 46.

Upon placement of first PCBA 16 within bottom housing 12, connection pads 62 are generally aligned with and positioned generally adjacent to transmitter 46 as illustrated in FIG. 1. In one embodiment, pins 52 of transmitter 46 initially extend generally parallel to PCB 60, and therefore, generally parallel to the overall extension of PCBA 16. Pins 52 of transmitter 46 are bent to interface with connection pads 62 of PCBA 16. In particular, in one embodiment, pins 52 of transmitter 46 extend in a manner defining a top pin, a bottom pin, and two intermediate pins positioned between top and bottom pins. Each intermediate pin 52 is placed to interface with a connection pad 62 positioned upon first surface 68. Top pin 52 is bent down to interface with an additional connection pad 62 secured to first surface 68 of PCB 60.

In one embodiment, upon interface of each pin 52 with a connection pad 62, each pin 52 is soldered to the respective connection pad 62. In one embodiment, bottom pin 52 is bent up to interface with and is soldered to connection pad 62 formed on second surface 68 of PCB 60. In this respect, transmitter 46 is electrically connected to first PCBA 16. With this in mind, transmitter 46 is able to electrically communicate with integrated circuit 62 on PC 60 and to pass electrical information on to first portion of apertures 44 and the first array of pins 90.

Referring to FIGS. 5A and 5B in view of FIG. 1, second PCBA 18 is additionally positioned to interact with receiver 48 of OSA 14 and first PCBA 16. In one embodiment, upon positioning, PCB 100 of PCBA 18 extends generally perpendicular to the extension of pins 56 from receiver 48, and therefore, the overall extension of PCBA 18 is generally perpendicular to the extension of pins 56. More specifically, second PCBA 18 is positioned such that each pin 56 extending from receiver 48 is received through one of the plurality of apertures 120 defined in PCB 100. Accordingly, each pin 56 interfaces with a plating 122 surrounding each aperture 120. In one embodiment, each pin 56 is soldered to the respective plating 122.

Notably, due to the keep out area 124, PCB 100 is able to interface with receiver 48 without obstruction due to the location of additional components upon PCBA 18. Once pins 56 are electrically connected to second PCBA 18 through plating 122, receiver 48 is configured to communicate with integrated circuit 104 and, thereby, passes electrical information through integrated circuit 104 to connection pads 102. In one embodiment, upon assembly, integrated circuit 104 is positioned within about 10 mm from each of pins 56.

Upon positioning of second PCBA 18 to interface with pins 56 of receiver 48, second PCBA 18 is additionally positioned to generally align each connection pad 102 to interface with at least one of the second array of pins 92 extending above PCB 60. In one embodiment, upon assembly, second PCBA 18 is positioned generally perpendicular to first PCBA 16. In this respect, in one embodiment, due to elongated notch 118, a portion of second PCBA 18 extends over a portion of first PCBA adjacent pins 92. In one embodiment, second PCBA 18 is coupled to first PCBA 16 electrically and/or mechanically. In one embodiment, the connection between second PCBA 18 and first PCBA 16 is purely mechanical to provide for additional structural integrity to the overall assembly. In one embodiment, first PCBA 16 and second PCBA 18 may interact but are not secured to one another.

Once again, due to the width of each connection pad 102 some leeway is provided for positioning the connection pads 102 and the respective host interface pins 22 to account for manufacturing tolerances. In one embodiment, each of the respective second array of pins 92 is soldered to the respective connection pad 102. In this respect, receiver 48 can communicate through second PCBA 18 to second array 92 of host pins 22. In one embodiment, upon assembly of transceiver 10, an additional top housing or cover (not shown) is placed over OSA 14, first PCBA 16, and second PCBA 18 to interface with bottom housing 12 to substantially enclose OSA 14, first PCBA 16, and second PCBA 18.

Upon final assembly of transceiver 10, transceiver 10 is placed so host interface pins 22 are electrically connected to the host system. Accordingly, OSA 14 is able to communicate with the host system through host interface pins 22. In particular, transmitter 46 communicates with host system via the first array of pins 90 and receiver 48 communicates with host system via second array of pins 92. As such, transceiver 10 is configured to receive and transmit fiber optic signals via fiber optic cable 20 and to receive or transmit electrical signals to host system via host interface pins 22.

A transceiver, according to embodiments of the present invention, provides for a dual PCBA connection to an optical subassembly. In this manner, a single PCBA does not need to be defined that interfaces with both the transceiver and the receiver of the OSA. By providing the dual PCBA connection, the two PCBAs can be positioned relative to one another to provide for a secure fit even under relatively large manufacturing tolerances. In addition, a flex PCBA does not need to be provided to permit alignment with both the transmitter and the receiver of the OSA, thereby, providing a more reliable connection. Moreover, by providing a second PCBA that interfaces directly to the receiver, the receiver pins generally do not need to be substantially bent to interface with the second PCBA, which further increases the integrity of the electrical connection between second PCBA and the receiver of the OSA.

Furthermore, by providing a dual PCBA connection, the respective integrated circuits of each PCBA can be positioned nearer the relative transmitter or receiver to which it controls. By positioning the relative integrated circuit nearer to the respective transmitter or receiver, noise or other interference to communication between the integrated circuit and the respective transmitter or receiver is reduced, thereby, increasing the integrity of electrical communication between the OSA and the integrated circuits. Moreover, each PCBA is independently connected to specific host interface pins, thereby, increasing the reliability of receiver communication to a first printed circuit board or vice versa.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A transceiver comprising:
a transmitter configured to convert electrical signals to fiber optic signals;
a receiver configured to convert fiber optic signals to electrical signals;
a first printed circuit board assembly electrically coupled with the transmitter and configured to be electrically coupled with a host system via a first plurality of host interface pins; and
a second printed circuit board assembly electrically coupled with the receiver and configured to be electrically coupled with the host system via a second plurality of host interface pins.

2. The transceiver of claim 1, wherein the second printed circuit board assembly has a generally perpendicular orientation relative to the first printed circuit board assembly.

3. The transceiver of claim 1, wherein the first printed circuit board assembly is electrically independent of the second printed circuit board assembly.

4. The transceiver of claim 1, wherein the transmitter and the receiver are each part of an optical subassembly.

5. The transceiver of claim 1, wherein the receiver includes at least one connection pin electrically coupled to the second printed circuit board assembly, and the second printed circuit board assembly generally extends perpendicular to the extension of the at least one connection pin.

6. The transceiver of claim 5, wherein the second printed circuit board assembly includes at least one aperture configured to receive the at least one connection pin.

7. The transceiver of claim 6, wherein the at least one connection pin includes four connection pins, the at least one aperture includes four apertures, and each of the four connection pins is received by a different one of the four apertures.

8. The transceiver of claim 5, wherein each of the at least one connection pins is generally straight when coupled to the second printed circuit board assembly.

9. The transceiver of claim 1, wherein the receiver includes at least one connection pin electrically coupled to the second printed circuit board assembly, and the second printed circuit board assembly includes an integrated circuit for controlling the receiver, wherein the integrated circuit is positioned less than about 10 mm from the at least one connection pin.

10. The transceiver of claim 1, wherein the second printed circuit board assembly includes a plurality of connection pads, and each of the plurality of connection pads extends parallel to the second plurality of host interface pins, wherein each of the second plurality of host interface pins is soldered to one of the plurality of connection pads.

11. The transceiver of claim 1, wherein the transceiver is a small form factor transceiver.

12. A transceiver comprising:
a transmitter configured to convert electrical signals to fiber optic signals;
a receiver configured to convert fiber optic signals to electrical signals, the receiver including a plurality of connection pins;
a printed circuit board assembly positioned generally perpendicular to and electrically coupled to each of the plurality of connector pins of the receiver.

13. The transceiver of claim 12, wherein the printed circuit board assembly is a first printed circuit board assembly, and the transceiver further comprises:
a second printed circuit board assembly electrically coupled to the transmitter.

14. The transceiver of claim 13, wherein the second printed circuit board assembly extends generally perpendicular to the first printed circuit board assembly.

15. The transceiver of claim 13, wherein the plurality of connection pins is a first plurality of connection pins, and the transmitter includes a second plurality of connection pins, further wherein the second printed circuit board extends generally parallel to each of the second plurality of connection pins.

16. The transceiver of claim 12, wherein the transmitter and the receiver are each part of a bi-directional optical subassembly.

17. The transceiver of claim 16, wherein the printed circuit board assembly includes an integrated circuit configured to electrically control the receiver, and further wherein the integrated circuit is positioned less than 10 mm from each of the plurality of connector pins.

18. The transceiver of claim 12, wherein the printed circuit board assembly includes a plurality of connection pads, and the transceiver further includes:
a plurality of host interface pins configured to electrically interface with a host system, wherein each of the plurality of host interface pins extends generally parallel to the extension of each of the plurality of connection pads.

19. A transceiver comprising:
a transmitter configured to convert electrical signals to fiber optic signals;
a receiver configured to convert fiber optic signals to electrical signals;
means for coupling the transmitter to a host computing system;
means for coupling the receiver to the host computing system;
wherein the means for coupling the transmitter and the means for coupling the receiver are electrically independent of each other.

20. The transceiver of claim 19, wherein the means for coupling the transmitter includes:
means for electrically controlling the transmitter.

21. The transceiver of claim 19, wherein the means for coupling the receiver includes:
means for electrically interfacing with the receiver, and
means for electrically controlling the receiver, wherein the means for electrically controlling the receiver is positioned less than about 10 mm from the means for electrically interfacing with the receiver.

22. The transceiver of claim 21, wherein the means for coupling the receiver additionally includes:
means for electrically interfacing with a plurality of host interface pins, wherein the plurality of host interface pins is characterized by an absence of electrical coupling with the means for coupling the transmitter to the host computing system.

23. A transceiver comprising:
an optical subassembly including:
a transmitter configured to convert electrical signals to fiber optic signals, the transmitter including a first plurality of connection pins, and
a receiver configured to convert fiber optic signals to electrical signals, the receiver including a second plurality of connection pins;
a first printed circuit board assembly electrically coupled to the first plurality of connection pins, the first printed circuit board is configured to be electrically coupled with a host system via a first plurality of host interface pins; and
a second printed circuit board assembly positioned generally perpendicular to and electrically coupled to the second plurality of connection pins, the second printed circuit board is configured to be electrically coupled with the host system via a second plurality of host interface pins independent from the first plurality of host interface pins.
